(19) United States
(12) Patent Application Publication
(10) Pub. No.: US 2011/0018826 A1
(43) Pub. Date: Jan. 27, 2011

(54) ELECTROSTATIC CAPACITANCE TYPE INPUT APPARATUS AND DISPLAY APPARATUS WITH INPUT FUNCTION INCLUDING THE SAME

(75) Inventor: Hinata Shoji, Nagano (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/838,821

(22) Filed: Jul. 19, 2010

(30) Foreign Application Priority Data
Jul. 24, 2009 (JP) P2009-172845

(51) Int. Cl. G06F 3/041; G08C 21/00

(52) U.S. Cl. 345/173; 178/18.01

(57) ABSTRACT

Disclosed herein is an electrostatic capacitance type input apparatus, including, a first substrate, a flexible second substrate disposed so as to face the first substrate, a first electrode for detection of a depressed position, the first electrode being provided either on a surface side, in the first substrate, facing the flexible second substrate or on a side opposite to the flexible second substrate with respect to the first substrate, a second electrode for detection of a depressed position, the second electrode being provided on the flexible second substrate, and an elastic member having an insulating property and provided between the first substrate and the flexible second substrate.

### CROSS REFERENCES TO RELATED APPLICATIONS

The present application claims priority to Japanese Priority Patent Application JP 2009-172845 filed in the Japan Patent Office on Jul. 24, 2009, the entire content of which is hereby incorporated by reference.

### BACKGROUND

The present application relates to an electrostatic capacitance type input apparatus for detecting an input position in accordance with a change in corresponding one of electrostatic capacitances coupled to respective electrode, and a display apparatus with an input function including the electrostatic capacitance type input apparatus.

With regard to electronic apparatuses such as a mobile phone, a car navigation system, a personal computer, a ticket-vending machine, and a terminal installed in a bank, in recent years, an electronic apparatus is known in which an input apparatus called a touch panel is disposed on a surface of a liquid crystal device or the like, and information can be inputted while reference is made to an image displayed in an image display area of the liquid crystal device. Of those input apparatus, an electrostatic capacitance type input apparatus monitors electrostatic capacitances coupled to a plurality of electrodes for detection of an input position, respectively. Therefore, when a finger comes close to any one of a plurality of electrodes for the detection of the input position, the electrostatic capacitance is increased in the electrode to which the finger comes close by an electrostatic capacitance caused between the electrode concerned and the finger. As a result, it is possible to specify the electrode to which the finger comes close. The electrostatic capacitance type input apparatus, for example, is described in Japanese Patent Laid-Open No. 2003-99185.

### SUMMARY

However, the electrostatic capacitance type input apparatus described in Japanese Patent Laid-Open No. 2003-99185 involves a problem such that since the electrostatic capacitance caused between the finger as a conductor and the electrode for the detection of the input position is utilized, unlike the case of a resistance film type input apparatus, pen input cannot be carried out unless a specific pen is used.

The inventor of this application proposes herein an electrostatic capacitance type input apparatus in which a first substrate and a second substrate are disposed so as to face each other, and electrodes for detection of a depressed position are provided in the first substrate side and the second electrode side, respectively. With such an electrostatic capacitance type input apparatus, when the second substrate is depressed, a distance between the electrode on the first substrate side, and the electrode on the second substrate side is narrowed in the depressed portion. Therefore, since the electrostatic capacitance between the electrodes is changed in the depressed portion, the input position can be detected. For this reason, even in the case of the electrostatic capacitance type input apparatus, the pen input becomes possible.

In such an electrostatic capacitance type input apparatus, however, the flexible substrate is used as the second substrate, and an air layer is interposed between the first substrate and the second substrate. Therefore, there are problems that a nonconformity that even when the second substrate is not depressed, the second substrate is deformed toward the first substrate and so forth, and a nonconformity that even when the depression against the second substrate is released, the second substrate is not returned to the original shape and so forth tend to happen. In addition, there is another problem that since the mechanical strength of the second substrate is low, the second substrate is damaged when an unnecessary external force is applied to the second substrate, and so forth.

The present application has been made in order to solve the problems described above, and it is therefore desirable to provide an electrostatic capacitance type input apparatus with which input can be carried out by using a pen or the like other than a finger, and in which generation of unnecessary deformation and damage in a substrate located on a manipulation surface side can be suppressed, and a display apparatus with an input function including the electrostatic capacitance type input apparatus.

In order to attain the desire described above, according to an embodiment, there is provided an electrostatic capacitance type input apparatus including: a first substrate; a flexible second substrate disposed so as to face the first substrate; a first electrode for detection of a depressed position, the first electrode being provided either on a surface side, in the first substrate, facing the flexible second substrate or on a side opposite to the flexible second substrate with respect to the first substrate; a second electrode for detection of a depressed position, the second electrode being provided on the flexible second substrate; and an elastic member having an insulating property and provided between the first substrate and the flexible second substrate.

In an embodiment, the first electrode for the detection of the depressed position is provided either on the surface side, in the first substrate, facing the flexible second substrate on the side opposite to the flexible second substrate with respect to the first substrate. Also, the second electrode for the detection of the depressed position is provided on the flexible second substrate. For this reason, when the flexible second substrate is depressed to be bent toward the first substrate side, a distance between the first electrode and the flexible second electrode is narrowed in a portion in which the flexible second substrate is bent. As a result, an electrostatic capacitance between the first electrode and the flexible second electrode is increased in such a portion. Therefore, when the electrostatic capacitance about either the first electrode or the flexible second electrode is monitored, it is possible to detect a position where the flexible second substrate is depressed. For this reason, even with the electrostatic capacitance type input apparatus, the input manipulation can be carried out by using the pen or the like other than the finger. In addition, since the elastic member having the insulating property is provided between the first substrate and the flexible second substrate, the flexible second substrate is supported from the first substrate side by the elastic member having the insulating property. For this reason, the mechanical strength of the flexible second substrate is high as compared with the case where the air layer is interposed between the first substrate and the second substrate. Therefore, it is possible to suppress nonconformities that even when the second substrate is not depressed, the second substrate is deformed toward the first substrate, and so forth, and the nonconformity that even after the depression against the second substrate is released, the second substrate is not returned to the original shape because the second substrate is held deformed, and so forth. In addition, it is possible to avoid the causing of the problem such that when the unnecessary external force is applied to the second substrate, the second substrate is damaged, and so forth.

Preferably, the flexible second substrate is made from a plastic sheet. When the second substrate is made from the plastic sheet, especially, the nonconformity that even when the second substrate is not depressed, the second substrate is deformed toward the first substrate, and so forth, and the nonconformity that even after the depression against the second substrate is released, the second substrate is not returned to the original shape because the second substrate is held deformed, and so forth are easy to cause. However, according to the embodiment, it is possible to reliably suppress the causing of such nonconformities. In addition, although when the second substrate is made from the plastic sheet, the second substrate is easy to damage, according to the embodiment, it is possible to reliably suppress the generation of such a damage.

Preferably, the elastic member having the insulating property is a gel-like sheet which is disposed so as to be interposed between the first substrate and the flexible second substrate. When such a structure is adopted, it is easy to provide the elastic member having the insulating property between the first substrate and the flexible second substrate.

Preferably, the gel-like sheet is adhered to each of the first substrate and the flexible second substrate. By adopting such a structure, since the flexible second substrate is disposed integrally with the first substrate through the gel-like sheet, it is possible to further increase the mechanical strength of the flexible second substrate.

Preferably, an elastic modulus of the gel-like sheet under a condition in which a temperature is 20° C. is equal to or larger than 1×10⁴N/m², and is equal to or smaller than 1×10⁸ N/m². When the elastic modulus of the gel-like sheet is smaller than 1×10⁴N/m², it may be impossible to sufficiently reinforce the flexible second substrate because the gel-like sheet is too soft. On the other hand, when the elastic modulus of the gel-like sheet exceeds 1×10⁸ N/m², a large pen pressure is required during the pen input because the flexible second substrate comes to be hardly deformed. For this reason, the elastic modulus of the gel-like sheet is preferably equal to or larger than 1×10⁴N/m², and is equal to or smaller than 1×10⁸ N/m².

Preferably, a light blocking member is provided along an outer peripheral edge of the flexible second substrate in any one of a first surface of the flexible second substrate, between the flexible second substrate and the gel-like sheet, and between the gel-like sheet and the first substrate. By adopting such a structure, even when a light leaks from the side of the first substrate toward the outer peripheral edge of the flexible second substrate, it is possible to block the leakage of such a light.

Preferably, the first substrate includes a protrusion portion protruding from an end edge of the flexible second substrate, and a light blocking member is provided in the protrusion portion along an outer peripheral edge of the flexible second substrate. By adopting such a structure, even when a light leaks from the side of the first substrate toward the outer peripheral edge of the flexible second substrate, it is possible to block the leakage of such a light. In addition, when the structure is adopted such that the light blocking member is provided in the protrusion portion of the first substrate, for example, during assembly of the electrostatic capacitance type input apparatus, the light blocking member may be provided in any of a process before the first substrate and the flexible second substrate are stuck to each other through the gel-like sheet, or a process after the first substrate and the flexible second substrate are stuck to each other through the gel-like sheet. Therefore, it is possible to efficiently carry out a work for assembling the electrostatic capacitance type input apparatus.

According to another embodiment, there is provided a display apparatus with an input function including the electrostatic capacitance type input apparatus according to the embodiment; in which an image producing device is provided so as to be disposed on a side opposite to the flexible second substrate side with respect to the first substrate.

The display apparatus with the input function according to the embodiments of the present application is used in electronic apparatuses such as a mobile phone, a car navigation system, a personal computer, a ticket-vending machine, and a terminal installed in a bank.

Additional features and advantages are described herein, and will be apparent from the following Detailed Description and the figures.

### BRIEF DESCRIPTION OF THE FIGURES

FIG. 1 is an explanatory perspective view schematically showing an entire structure of a display apparatus with an input function according to Embodiment 1;

FIGS. 2A and 2B are respectively an explanatory top plan view schematically showing a planar structure of the display apparatus with the input function according to Embodiment 1, and an explanatory cross sectional view schematically showing a cross sectional structure of the display apparatus with the input function according to Embodiment 1;

FIGS. 3A and 3B are respectively an explanatory top plan view showing a planar positional relationship of the first electrode formed on the first substrate of the electrostatic capacitance type input apparatus, and an explanatory top plan view showing a planar structure of the second electrode formed on the second substrate of the electrostatic capacitance type input apparatus;

FIGS. 4A to 4D are respectively an explanatory top plan view showing a planar structure of an electrode pattern composing the second electrodes, a cross sectional view taken on line A-A′ of FIG. 4A, a cross sectional view taken on line B-B′ of FIG. 4A, and a cross sectional view taken on line C-C′ of FIG. 4A;

FIGS. 5A to 5C are respectively explanatory cross sectional views explaining an operation of the electrostatic capacitance type input apparatus in the display apparatus with the input function of Embodiment 1;

FIGS. 6A and 6B are respectively an explanatory perspective view schematically showing an entire structure of a display apparatus with an input function according to Change of Embodiment 1, and an explanatory cross sectional view schematically showing a cross sectional structure of the display apparatus with the input function according to Change of Embodiment 1;

FIG. 7 is an explanatory perspective view schematically showing an entire structure of a display apparatus with an input function according to Embodiment 2;

FIGS. 8A and 8B are respectively an explanatory top plan view schematically showing a planar structure of the display apparatus with the input function according to Embodiment 2, and an explanatory cross sectional view schematically showing a cross sectional structure of the display apparatus with the input function according to Embodiment 2;

FIGS. 9A and 9B are respectively an explanatory perspective view schematically showing a planar structure of a display apparatus with an input function according to Embodiment 3, and an explanatory cross sectional view schematically showing a cross sectional structure of the display apparatus with the input function according to Embodiment 3;

FIGS. 10A and 10B are respectively an explanatory cross sectional view schematically showing an entire structure of a display apparatus with an input function according to Change of Embodiment 3, and an explanatory view schematically showing a cross sectional structure of the display apparatus with the input function according to Change of Embodiment 3;

FIGS. 11A and 11B are respectively an explanatory perspective view schematically showing a planar structure of a display apparatus with an input function according to Embodiment 4, and an explanatory cross sectional view schematically showing a cross sectional structure of the display apparatus with the input function according to Embodiment 4;

FIGS. 12A and 12B are respectively an explanatory top plan view when six second electrodes in total are formed on a second substrate, and an explanatory top plan view when 12 second electrodes in total are formed on the second substrate;

FIGS. 13A and 13B are respectively an explanatory top plan view showing a structure of a first electrode, and an explanatory top plan view showing a structure of a second electrode; and

FIGS. 14A, 14B and 14C are respectively an explanatory perspective view showing a construction of a mobile type personal computer including the display apparatus with the input function, an explanatory perspective view showing a construction of a mobile phone including the display apparatus with the input function, and an explanatory perspective view showing a construction of PDA (personal digital assistance) including the display apparatus with the input function.

### DETAILED DESCRIPTION

The present application will be described below in greater detail with reference to the drawings according to an embodiment.

### Embodiment 1

### Entire Structure

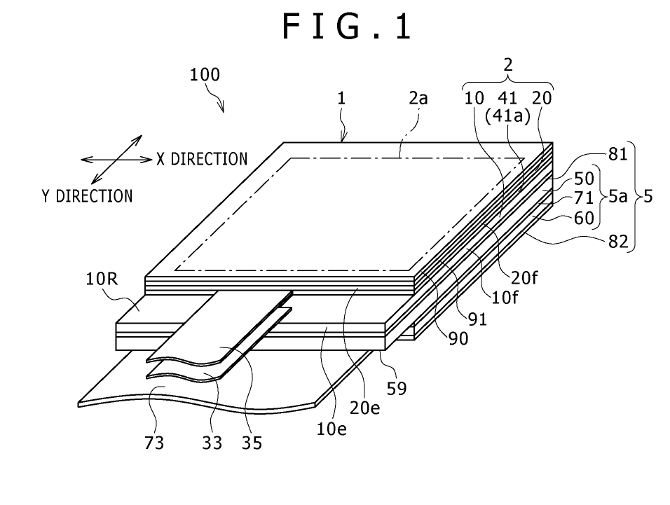

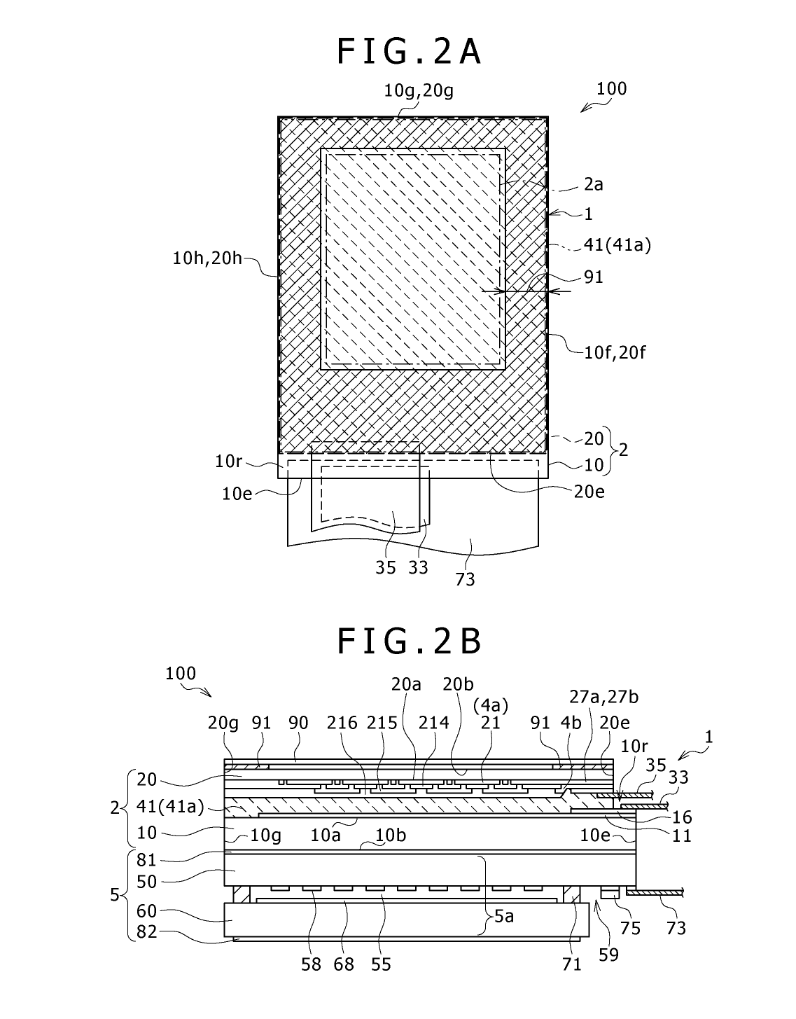

FIG. 1 is an explanatory perspective view schematically showing an entire structure of a display apparatus with an input function according to Embodiment 1. FIGS. 2A and 2B are respectively explanatory views schematically showing a positional relationship and the like of members composing the display apparatus with the input function according to Embodiment 1. That is to say, FIGS. 2A and 2B are respectively an explanatory top plan view schematically showing a planar structure of the display apparatus with the input function according to Embodiment 1, and an explanatory cross sectional view schematically showing a cross sectional structure of the display apparatus with the input function according to Embodiment 1. Note that, in FIG. 2A, a first substrate used in an electrostatic capacitance type input apparatus is represented by a heavy solid line, and a flexible second substrate used in the electrostatic capacitance type input apparatus is represented by a heavy and long dotted line. An input area is represented by a chain line, and a light blocking portion (light blocking member) of a transparent protective film is represented by a fine solid line and an area indicated by upward-sloping solid lines. Also, an elastic member (gel-like sheet) is represented by a two-dot chain line and an area indicated by downward-sloping dotted lines.

In FIG. 1, and FIGS. 2A and 2B, the display apparatus 100 with the input function of Embodiment 1 generally includes a liquid crystal device 5 as an image producing device, and an electrostatic capacitance type input apparatus 1 (touch panel) disposed so as to overlie a surface on a side from which a display light is emitted in the liquid crystal device 5. In this case, the electrostatic capacitance type input apparatus 1 includes an input panel 2. In Embodiment 1, each of the input panel 2 and a liquid crystal panel 5a has a rectangular planar shape. Also, a central area when the electrostatic capacitance type input apparatus 1 is planarly viewed is an input area 2a. In addition, in the liquid crystal device 5, an area which overlaps the input area 2a of the electrostatic capacitance type input apparatus 1 in terms of a planar view is an image display area.

The liquid crystal device 5 is a transmission type or semi-transmission and reflection type active matrix liquid crystal display apparatus, and includes a transmission type or semi-transmission and reflection type liquid crystal panel 5a. In the liquid crystal device 5, a backlight unit (not shown) is disposed on a side (a side opposite to an emission side of the display light) opposite to a side on which the electrostatic capacitance type input apparatus 1 is disposed with respect to the liquid crystal panel 5a. The backlight unit, for example, includes a translucent light guide plate, and a light source such as a light emitting diode. In this case, the translucent light guide plate is disposed so as to overlie the side opposite to the side on which the electrostatic capacitance type input apparatus 1 is disposed with respect to the liquid crystal panel 5a. Also, the light source emits a white light or the like to a side edge portion of the light guide plate. After the light emitted from the light source is made incident to the side edge portion of the light guide plate, the light is emitted to the liquid crystal panel 5a while it is propagated through the light guide plate. A sheet-like optical member such as a light scattering sheet or a prism sheet is disposed between the light guide plate and the liquid crystal panel 5a.

In the liquid crystal device 5, a first polarizing plate 81 is disposed on the emission side of the display light so as to overlie the liquid crystal panel 5a, and a second polarizing plate 82 is disposed on a side opposite to the emission side of the display light so as to underlie the liquid crystal panel 5a. For this reason, the electrostatic capacitance type input apparatus 1 is bonded to the first polarizing plate 81 by using a translucent adhesive agent (not shown) made of an acrylic resin or the like.

The liquid crystal panel 5a includes a translucent element substrate 50 disposed on the emission side of the display light, and a translucent counter substrate 60 disposed so as to face the translucent element substrate 50. The translucent counter substrate 60 and the translucent element substrate 50 are stuck to each other by using a rectangular frame-like seal material 71. Also, a liquid crystal layer 55 is held within an area surrounded by the rectangular frame-like seal material 71 between the counter substrate 60 and the translucent element substrate 50.

In the element substrate 50, a plurality of pixel electrodes 58 are each formed from a translucent conductive film such as an Indium Tin Oxide (ITO) film on the surface facing the counter substrate 60. Also, a common electrode 68 is formed from the translucent conductive film such as the ITO film on the surface facing the element substrate 50. It is noted that when the liquid crystal device 5 utilizes either an In Plane Switching (IPS) system or a Fringe Field switching (FFS) system, the common electrode 68 is provided on the element substrate 50 side. In addition, the element substrate 50 is disposed on the emission side of the display light in some cases. In the element substrate 50, a driving IC 75 is COG (Chip On Glass0-mounted to a protrusion area 59 protruding from the edge of the counter substrate 60, and a flexible substrate 73 is connected to the protrusion area 59. It is noted that a drive circuit is formed concurrently with a switching element on the element substrate 50 in some cases.

Detailed Structure of Input Apparatus 1

In the electrostatic capacitance type input apparatus 1 in the display apparatus 100 with the input function of Embodiment 1, the input panel 2 includes a translucent first substrate 10 made from a glass plate, a plastic plate or the like, and a translucent second substrate 20 made from a glass plate, a plastic plate, a plastic sheet or the like. When each of the translucent first substrate 10 and the translucent second substrate 20 is made of a plastic material, it is possible to use a heat-resistant translucent sheet made of a cyclic olefin resin or the like such as polyethylene terephthalate (PET), polycarbonate (PC), polyether sulfone (PES), polyimide (PI) or polynorbornene.

With regard to the first substrate 10 and the second substrate 20, first surfaces 10a and 20a are disposed so as to face each other through a predetermined gap. Also, an elastic member 41 which will be described later is provided between the first substrate 10 and the second substrate 20. Here, the second substrate 20 is disposed on an input manipulation side, and the first substrate 10 is disposed on a side of the liquid crystal device 5. For this reason, the first surface 20b of the second substrate 20 is directed toward the input manipulation side, and the second surface 10b of the first substrate 10 is directed toward the side of the liquid crystal device 5. In the electrostatic capacitance type input apparatus 1 in the display apparatus 100 with the input function of Embodiment 1, it is necessary that when the input manipulation is carried out, the second substrate 20 is depressed, and the second substrate 20 is bent toward the first substrate 10 in the depressed portion. For this reason, in Embodiment 1, the plastic sheet is used as the second substrate 20. In addition, the glass plate is used as the first substrate 10.

The first substrate 10 is slightly larger in size than the second substrate 20. Also, an end portion 10e of the first substrate 10 is structured in the form of a protrusion portion 10r protruding from an end portion 20e of the second substrate 20. However, with regard to the first substrate 10 and the second substrate 20, end portions 10f and 20f, end portions 10g and 20g, and end portions 10h and 20h other than the end portions 10e and 20e are stacked on top of each other.

As details will be described later, a first electrode 11 for detection of a depressed position is formed on the first surface 10a of the first substrate 10, and a plurality of second electrodes 21 for detection of a depressed position are formed on the first surface 20a of the second substrate 20. In addition, in the first surface 10a of the first substrate 10, a flexible substrate 33 in which a wiring electrically connected to the first electrode 11 is formed is connected to the protrusion portion 10r. Also, in the first surface 20a of the second substrate 20, a flexible substrate 35 in which wirings electrically connected to the second electrodes 21, respectively, are formed is connected to the end portion 20e on the side on which the protrusion portion 10r of the first substrate 10 is located.

In the electrostatic capacitance type input apparatus 1 structured in the manner as described above, a transparent protective film 90 is stuck to the second surface 20b of the second substrate 20 so as to cover the surface of the second substrate 20. A rectangular frame-like light blocking portion 91 as a light blocking member colored with black or the like is provided on the transparent protective film 90 along an outer peripheral edge of the transparent protective film 90. Also, an area surrounded by the rectangular frame-like light blocking portion 91 is the input area 2a. Such a light blocking portion 91 overlies outer peripheral edges of the first substrate 10 and the liquid crystal panel 5a. Thus, the rectangular frame-like light blocking portion 91 blocks a light which leaks from the light source of the liquid crystal device 5, and the end portion of the light guide plate, thereby being prevented from leaking from the second substrate 20 to the emission side (input manipulation side) of the display light.

Electrode Structure of Input Apparatus 1

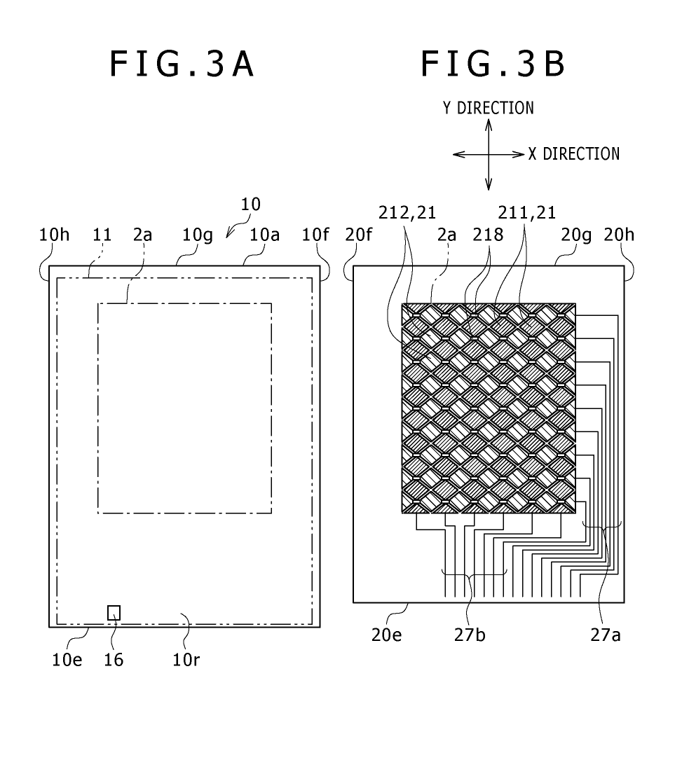

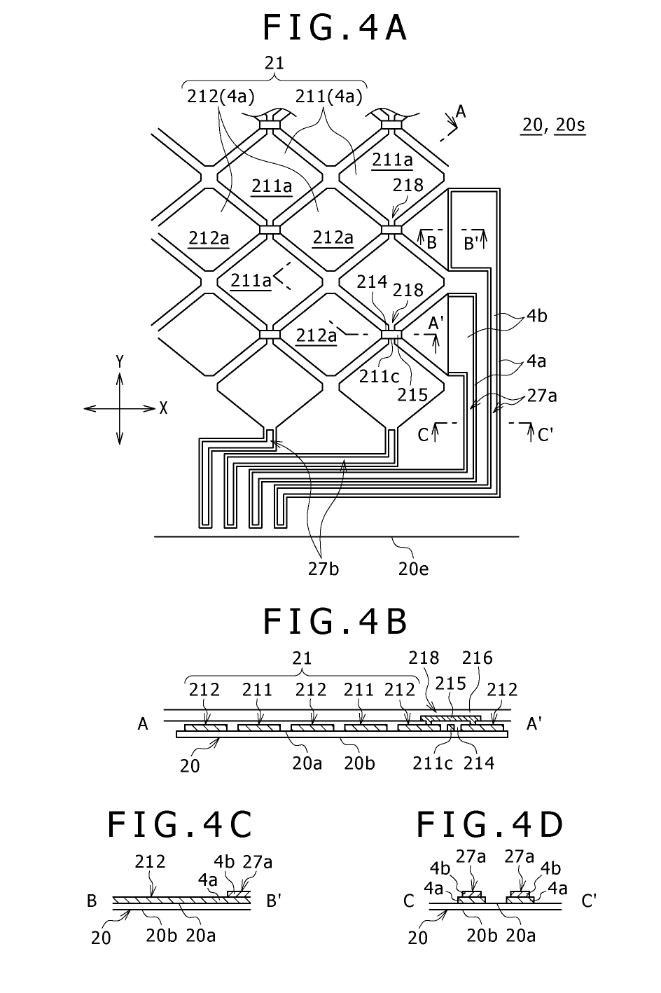

FIGS. 3A and 3B are respectively explanatory views schematically showing a planar layout of the electrodes formed in the electrostatic capacitance type input apparatus 1 in the display apparatus 100 with the input function of Embodiment 1. That is to say, FIGS. 3A and 3B are respectively an explanatory top plan view showing a planar positional relationship of the first electrode 11 formed on the first substrate 10 of the electrostatic capacitance type input apparatus 1, and an explanatory top plan view showing a planar structure of the second electrodes 21 formed on the second substrate 20 of the electrostatic capacitance type input apparatus 1. Also, FIGS. 4A to 4D are respectively explanatory views each schematically showing the second substrate 20 used in the electrostatic capacitance type input apparatus 1 in the display apparatus 100 with the input function of Embodiment 1. That is to say, FIGS. 4A to 4D are respectively an explanatory top plan view showing a planar structure of an electrode pattern composing the second electrodes 21, a cross sectional view taken on line A-A′ of FIG. 4A, a cross sectional view taken on line B-B′ of FIG. 4A, and a cross sectional view taken on line C-C′ of FIG. 4A. It is noted that in the following description, directions intersecting with each other (directions making at a right angle with each other in Embodiment 1) on each of the substrate surfaces of the first substrate 10 and the second substrate 20 used in the electrostatic capacitance type input apparatus 1 are defined as an X-direction and a Y-direction, respectively.

As shown in FIGS. 2B and 3A, in the electrostatic capacitance type input apparatus 1 in the display apparatus 100 with the input function of Embodiment 1, the translucent first electrode 11 made from the ITO film is formed over the entire wide rectangular area including the input area 2a on the first substrate 10a of the first substrate 10. A terminal 16 is formed in the end portion of the first electrode 11 in the end portion 10e of the first substrate 10, and the wiring of the flexible substrate 33 shown in FIG. 1 is electrically connected to the terminal 16.

As shown in FIGS. 2B and 3B, and FIGS. 4A and 4B, a plurality of second electrodes 21 are formed inside the input area 2a on the first surface 20a of the second substrate 20. The second electrodes 21 include a plurality line of first translucent electrode patterns 211 each extending in a first direction (a direction indicated by an arrow Y), and a plurality line of second translucent electrode patterns 212 each extending in a second direction (a direction indicated by an arrow X) intersecting with the first direction. The first translucent electrode patterns 211 and the second translucent electrode patterns 212 are each made from the first conductive film 4a such as the ITO film.

In Embodiment 1, the first translucent electrode patterns 211 and the second translucent electrode patterns 212 are formed in the form of the same layer on the same surface (the first surface 20a) of the second substrate 20. For this reason, a plurality of intersection portions 218 between the first translucent electrode patterns 211 and the second translucent electrode patterns 212 exist on the first surface 20a of the second substrate 20. Then, in Embodiment 1, the first translucent electrode patterns 211 continuously extend in the Y-direction, whereas the second translucent electrode patterns 212 are interrupted in the respective intersection portions 218. In addition, a translucent interlayer insulating film 214 made from a silicon oxide film or the like is formed on an upper layer side of the first translucent electrode patterns 211 and the second translucent electrode patterns 212. Also, a translucent relay electrode 215 through which the second translucent electrode patterns 212 interrupted in the respective intersection portions 218 are electrically connected to each other is formed so as to overlie the translucent interlayer insulating film 214. For this reason, the second translucent electrode patterns 212 are electrically connected to one another in the X-direction. In Embodiment 1, the relay electrode 215 is made from a second conductive film 4b such as the ITO film. In addition, a protective film 216 made from a silicon oxide film or the like is formed over the relay layer 215. It is noted that the interlayer insulating film 214 may also be formed only in each of the intersection portions 218.

The first translucent electrode patterns 211 and the second translucent electrode patterns 212 include rhomboid-shaped pad portions 211a and 212a each having a large area (large area portions), respectively, in areas each of which is held between the corresponding ones of the intersection portions 218. Also, each of interlinking portions 211c located in the respective intersection portions 218 in the first translucent electrode patterns 211 has a fine width shape narrower than that of each of the pad portions 211a. In addition, each of the relay electrodes 215 is formed in a strip so as to have a fine width shape narrower than that of each of the pad portions 211a and 212a.

Wirings 27a and wirings 27b which extend from the first translucent electrode patterns 211 and the second translucent electrode patterns 212, respectively, are formed in an external area of the input area 2a on the first surface 20a of the second substrate 20. End portions of the wirings 27a and the wirings 27b are structured in the form of terminals, and the wirings of the flexible substrate 35 shown in FIG. 1 are electrically connected to the terminals of the wirings 27a and the wirings 27b, respectively.

In Embodiment 1, for structuring the wirings 27a and the wirings 27b, as shown in FIGS. 4A, 4B, 4C, and 4D, firstly, the first conductive film 4a composing the first translucent electrode patterns 211 and the second translucent electrode patterns 212 is made to extend along the formation area of the wirings 27a and the wirings 27b. In addition, in Embodiment 1, the second conductive film 4b composing the relay electrodes 215 is laminated on each of the wirings 27a and the wirings 27b. For this reason, each of the wirings 27a and the wirings 27b has a multilayer structure, and thus has a low wiring resistance.

Structure Between First Substrate 10 and Second Substrate 20

In Embodiment 1, the elastic member 41 having both the insulating property and the translucency is provided between the first substrate 10 and the second substrate 20. In Embodiment 1, the elastic member 41 is a translucent gel-like sheet 41a which is disposed so as to overlie and underlie the first substrate 10 and the second substrate 20, respectively. The gel-like sheet 41a is made of a silicon resin, an urethane resin, an acrylic resin or the like having both the translucency and the elasticity, and a thickness thereof is in the range of 100 to 500 μm. In Embodiment 1, a member having an elastic modulus which is equal to or larger than 1×10⁴N/m², and is equal to or smaller than 1×10⁸ N/m² is used as the gel-like sheet 41a. A product name “αGEL (registered trademark)” manufactured by Taica Corporation can be exemplified as the gel-like sheet 41a.

Here, the gel-like sheet 41a has an adherence property, and thus the gel-like sheet 41a is adhered to each of the first surface 10a side of the first substrate 10, and the second substrate 20a side of the second substrate 20. For this reason, the first substrate 10 and the second substrate 20 are disposed integrally with each other through the gel-like sheet 41a, and thus no air layer is interposed between the first substrate 10 and the second substrate 20.

Method of Manufacturing Electrostatic Capacitance Type Input Apparatus 1 and Display Apparatus 100 with Input Function

For manufacturing the display apparatus 100 with the input function of Embodiment 1, firstly, the liquid crystal device 5 is assembled, and at the same time, the first substrate 10 including the first electrode 11 and the like, and the second substrate 20 including the second electrodes 21 and the like are manufactured. Next, after the flexible substrate 33 is connected to the first substrate 10, the second surface 10b of the first substrate 10 is stuck to the liquid crystal device 5. According to this method, there is obtained such an advantage that an influence of heat and a stress when the flexible substrate 33 is connected to the first substrate 10 is not exerted on the liquid crystal device 5 side. It is noted that after the second surface 10b of the first substrate 10 is stuck to the liquid crystal device 5, the flexible substrate 33 may be connected to the first substrate 10.

On the other hand, with regard to the second substrate 20, the gel-like sheet 41a is stuck to the first surface 20a side. Such a gel-like sheet 41a is normally supplied in the form of a large-sized sheet or a roll-like sheet in a state in which both surfaces of the gel-like sheet 41a contact a peeling sheet. Therefore, in a process for sticking the gel-like sheet 41a to the first surface 20a side of the second substrate 20, after the gel-like sheet 41a is stuck to the first surface 20a side of the second substrate 20 with the peeling sheet being peeled off from one surface of the gel-like sheet 41a, the gel-like sheet 41a has to be cut out to have approximately the same size as that of the second substrate 20. It is noted that after the gel-like sheet 41a is previously cut out to have approximately the same size as that of the second substrate 20, the gel-like sheet 41a may be stuck to the first surface 20a side of the second substrate 20. In any case, preferably, after the flexible substrate 35 is connected to the second substrate 20, the gel-like sheet 41a is stuck to the first surface 20a side of the second substrate 20.

Next, the first surface 10a of the first substrate 10 is stacked on the other surface side of the gel-like sheet 41a, and thus the first substrate 10 and the second substrate 20 are disposed integrally with each other through the gel-like sheet 41a. Next, the transparent protective film 90 having the rectangular frame-like light blocking portion 92 is stuck to the second surface 20b of the second substrate 20.

Another Method of Manufacturing Electrostatic Capacitance Type Input Apparatus 1 and Display Apparatus 100 with Input Function

In the method described above, after the gel-like sheet 41a is stuck to the second substrate 20, the first substrate 10 and the second substrate 20 are disposed integrally with each other through the gel-like sheet 41a. However, after the gel-like sheet 41a is stuck to the first substrate 10, the first substrate 10 and the second substrate 20 may be disposed integrally with each other through the gel-like sheet 41a.

In addition, in the method described above, after the first substrate 10 and the second substrate 20 are disposed integrally with each other through the gel-like sheet 41a, the transparent protective film 90 having the rectangular frame-like light blocking portion 92 is stuck to the second surface 20b of the second substrate 20. Alternatively, however, before the first substrate 10 and the second substrate 20 are disposed integrally with each other through the gel-like sheet 41a, the transparent protective film 90 may be stuck to the second surface 20b of the second substrate 20. In this case, there may be adopted a method such that after both the gel-like sheet 41a and the rectangular frame-like transparent protective film 90 are stuck to the second substrate 20, both the gel-like sheet 41a and the rectangular frame-like transparent protective film 90 are cut out. Or, there may also adopted a method such that after both the gel-like sheet 41a and the rectangular frame-like transparent protective film 90 are stuck to the second substrate 20, the gel-like sheet 41a, the second substrate 20 and the transparent protective film 90 are cut out. According to such a method, it is possible to justify the outer peripheral edges of the gel-like sheet 41a, the second substrate 20 and the transparent protective film 90.

Operation of Electrostatic Capacitance Type Input Apparatus 1

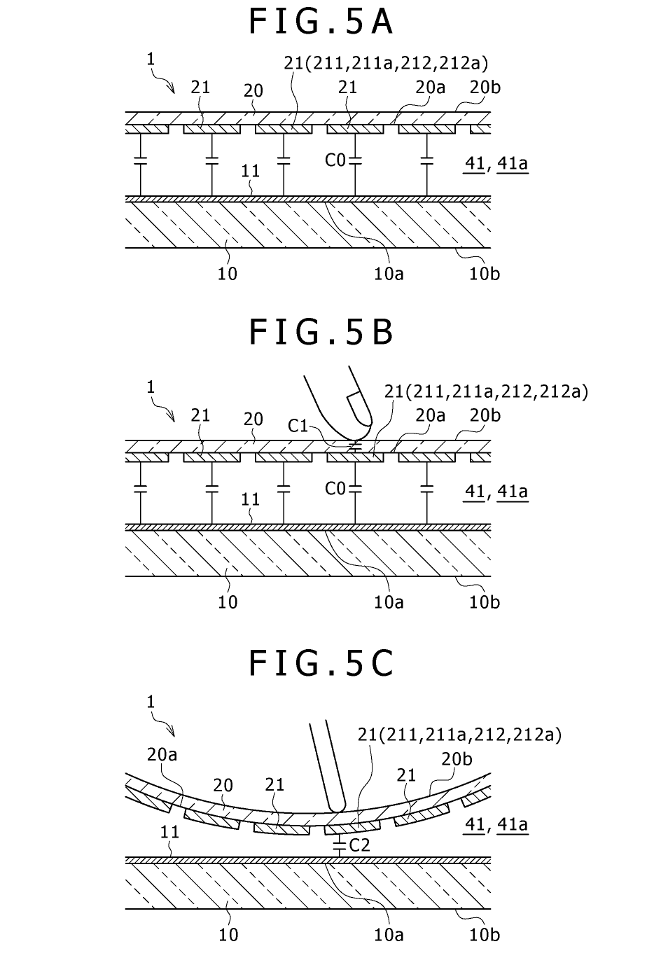

FIGS. 5A to 5C are respectively explanatory cross sectional views explaining an operation of the electrostatic capacitance type input apparatus 1 in the display apparatus 100 with the input function of Embodiment 1. In the electrostatic capacitance type input apparatus 1 in the display apparatus 100 with the input function of Embodiment 1, a constant electric potential such as the ground electric potential is applied to the first electrode 11 through the flexible substrate 33. Also, electrostatic capacitances coupled to a plurality of second electrodes 21 (the first translucent electrode patterns 211 and the second translucent electrode patterns 212), respectively, are monitored in accordance with a signal outputted through the flexible substrate 35. In this monitoring operation, in a state in which as shown in FIG. 5A, there is no proximity or the like of the finger to the second substrate 20, electrostatic capacitances C0 produced in respective facing portions between the pad portions 211a, 212a, and the first electrode 11 are detected from a plurality of second electrodes 21.

In this state, when as shown in FIG. 5B, the finger approaches the second surface 20b of the second substrate 20, an electrostatic capacitance which is obtained by adding an electrostatic capacitance C1 produced between the finger and the pad portion 211a, 212a to the electrostatic capacitance C0 is detected in the second electrode 21 (the first translucent electrode pattern 211 and the second translucent electrode pattern 212) located in the approach portion. Therefore, it is possible to detect the position where the finger approaches the second substrate 20.

In addition, when as shown in FIG. 5C, the second surface 20b of the second substrate 20 is depressed by using a pen, the second substrate 20 is bent toward the first substrate 10 in the depressed portion, so that the second electrode 21 (the first translucent electrode pattern 211 and the second translucent electrode pattern 212) approaches the first electrode 11. As a result, the electrostatic capacitance C0 produced in the facing portion between the pad portion 211a, 212a and the first electrode 11 is increased up to an electrostatic capacitance C2 (C0<C2) in the depressed portion. Such an increase in the electrostatic capacitance is detected through the second electrode 21 (the first translucent electrode pattern 211 and the second translucent electrode pattern 212). Therefore, it is possible to detect the portion in which the second substrate 20 is depressed by using the pen.

It is noted that when the second substrate 20 is depressed by using the finger from the state shown in FIG. 5B, an electrostatic capacitance which is obtained by adding the electrostatic capacitance C2 to the electrostatic capacitance C1 is detected from the second electrode 21 (the first translucent electrode pattern 211 and the second translucent electrode pattern 212) in the depressed portion. Therefore, information to be inputted may be selected in the state shown in FIG. 5B, and the information to be inputted may be decided in accordance with the state shown in FIG. 5B, and the information to be inputted may be decided in accordance with the method shown in FIG. 5C.

Effect of Embodiment 1

As set forth hereinabove, in the electrostatic capacitance type input apparatus 1, and the display apparatus 100 with the input function of Embodiment 1, the first electrode 11 for the detection of the depressed position is provided on the first surface 10a side, in the first substrate 10, facing the second substrate 20. Also, a plurality of second electrodes 21 for the detection of the depressed position are provided on the first surface 20a of the flexible second substrate 20. For this reason, as described with reference to FIG. 5C, when the second substrate 20 is depressed to be bent toward the first substrate 10 side, a distance between the first electrode 11 and the second electrode 21 is shortened in the portion in which the second substrate 20 is bent. Thus, the electrostatic capacitance between the first electrode 11 and the second electrode 21 is increased in such a depressed portion. Therefore, when the electrostatic capacitances about a plurality of second electrodes 21 are monitored, it is possible to detect the position depressed against the second substrate 20. For this reason, even with the electrostatic capacitance type input apparatus 1, the input manipulation can be carried out by using the pen or the like other than the finger.

In addition, since the elastic member 41 (the gel-like sheet 41a) having the insulating property is provided between the first substrate 10 and the second substrate 20, the second substrate 20 is suppressed from the first substrate 10 side by the elastic member 41. For this reason, the mechanical strength of the second substrate 20 is high as compared with the case where the air layer is interposed between the first substrate 10 and the second substrate 20. Therefore, it is possible to suppress the nonconformity that even when no second substrate 20 is depressed, the second substrate 20 is deformed toward the first substrate 10, and so forth, and the nonconformity that even after the depression against the second substrate 20 is released, the second substrate 20 is not returned to the original shape because the second substrate 20 is held deformed, and so forth. In addition, it is possible to avoid the causing of a problem such that when the unnecessary external force is applied to the second substrate 20, the second substrate 20 is damaged, and so forth. In addition, since no air layer exists between the first substrate 10 and the second substrate 20, it is possible to prevent generation of a Newton ring when the second substrate 20 is depressed.

In particular, in Embodiment 1, the second substrate 20 is made from the plastic sheet. Thus, the nonconformity that even when no second substrate 20 is depressed, the second substrate 20 is deformed toward the first substrate 10, and so forth, and the nonconformity that even after the depression against the second substrate 20 is released, the second substrate 20 is not returned to the original shape because the second substrate 20 is held deformed, and so forth are easy to generate. However, according to Embodiment 1, it is possible to reliably suppress the generation of such nonconformities.

In addition, the elastic member 41 is made from the gel-like sheet 41a laminated between the first substrate 10 the second substrate 20. For this reason, when the first substrate 10 and the second substrate 20 are stuck to each other, the gel-like sheet 41a has to be disposed so as to be interposed between the first substrate 10 the second substrate 20. To this end, it is easy to provide the elastic member 41 between the first substrate 10 the second substrate 20.

In addition, since the gel-like sheet 41a has the adherence property, it is possible to adopt the structure such that the gel-like sheet 41a is adhered to each of the first surface 10a side of the first substrate 10, and the first surface 20a side of the second substrate 20. For this reason, since no air layer exists between the first substrate 10 and the gel-like sheet 41a, and between the second substrate 20 and the gel-like sheet 41a, it is also possible to prevent the generation of the Newton ring when the second substrate 20 is depressed. In addition, since the first substrate 10 and the second substrate 20 are disposed integrally with each other through the gel-like sheet 41a, it is possible to further increase the mechanical strength of the second substrate 20.

Moreover, since the elastic modulus of the gel-like sheet 41a is equal to or larger than 1×10⁴ N/m², and is equal to or smaller than 1×10⁸ N/m², the second substrate 20 can be sufficiently reinforced, and the pen pressure during the pen input can be set in the suitable range. That is to say, when the elastic modulus of the gel-like sheet is smaller than 1×10⁴ N/m², it may be impossible to sufficiently reinforce the flexible second substrate 20 because the gel-like sheet 41a is too soft. On the other hand, when the elastic modulus of the gel-like sheet exceeds 1×10⁸ N/m², the large pen pressure is required during the pen input because the flexible second substrate 20 comes to be hardly deformed. For this reason, the elastic modulus of the gel-like sheet is preferably equal to or larger than 1×10⁴ N/m², and is equal to or smaller than 1×10⁸ N/m².

[Change of Embodiment 1]

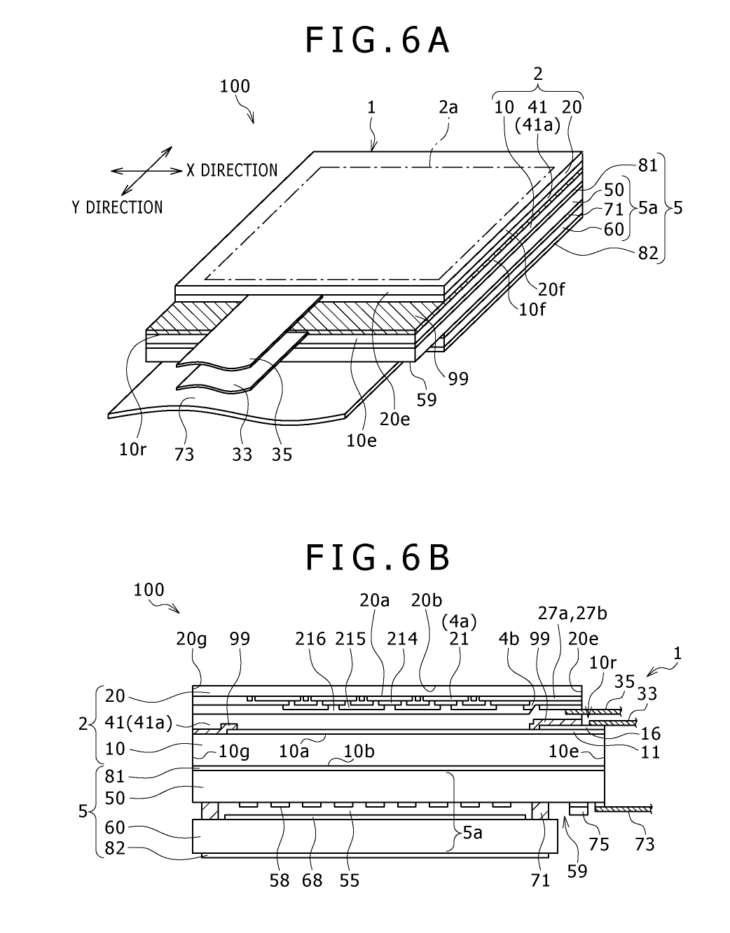

FIGS. 6A and 6B are respectively explanatory views schematically showing a structure of a display apparatus 100 with an input function according to Change of Embodiment 1 of the present invention. That is to say, FIGS. 6A and 6B are respectively an explanatory perspective view schematically showing an entire structure of the display apparatus 100 with the input function according to Change of Embodiment 1 of the present invention, and an explanatory cross sectional view schematically showing a cross sectional structure of the display apparatus 100 with the input function according to Change of Embodiment 1 of the present invention. It is noted that in FIG. 6A, the light blocking sheet as the light blocking member is represented by downward-sloping slant lines. In addition, since the basic structure of Change of Embodiment 1 is the same as that in the case of Embodiment 1, the common portions are designated by the same reference numerals, respectively, and a description thereof is omitted here for the sake of simplicity.

Referring to FIGS. 6A and 6B, the display apparatus 100 with the input function of Change of Embodiment 1 also includes the liquid crystal device 5 as the image producing device, and the electrostatic capacitance type input apparatus 1 disposed so as to overlie the surface on the side from which the display light is emitted in the liquid crystal device 5 similarly to the case of Embodiment 1. In Change of Embodiment 1, the liquid crystal device 5 includes the transmission type or semi-transmission and reflection type liquid crystal panel 5a. In the liquid crystal device 5, the backlight unit (not shown) is disposed on the side (the side opposite to the emission side of the display light) opposite to the side on which the electrostatic capacitance type input apparatus 1 is disposed with respect to the liquid crystal panel 5a.

In the electrostatic capacitance type input apparatus 1 in the display apparatus 100 with the input function of Change of Embodiment 1, the input panel 2 includes the translucent first substrate 10 made from the glass plate, the plastic plate or the like, and the translucent second substrate 20 made from the glass plate, the plastic plate, the plastic sheet or the like. In Change of Embodiment 1, the plastic sheet is used as the second substrate 20, and the glass plate is used as the first substrate 10. The first electrode 11 for the detection of the depressed position is formed on the first surface 10a of the first substrate 10, and a plurality of second electrodes 21 for the detection of the depressed position is formed on the first surface 20a of the second substrate 20.

The elastic member 41 having the insulating property is provided between the first substrate 10 and the second substrate 20. In Change of Embodiment 1, the elastic member 41 is the gel-like sheet 41a which is disposed between the first substrate 10 and the second substrate 20 so as to overlie and underlie the first substrate 10 and the second substrate 20, respectively. The gel-like sheet 41a is made of the silicon resin or the like having the translucency, the elasticity and the adherence property, and a thickness thereof is in the range of 100 to 500 μm. The member having the elastic modulus which is equal to or larger than 1×10⁴ N/m², and is equal to or smaller than 1×10⁸ N/m² is used as the gel-like sheet 41a.

In the electrostatic capacitance type input apparatus 1 structured in the manner as described above, for the purpose of blocking the light leaking from the light source of the liquid crystal device 5 or the end portion of the light guide plate, in Embodiment 1, the rectangular frame-like light blocking portion 91 is provided on the second surface 20b of the second substrate 20. In Change of Embodiment 1, however, a rectangular frame-like black light blocking sheet 99 is provided along the outer peripheral edge of the second substrate 20. With such a structure as well, the light blocking sheet 99 overlies each of the outer peripheral edges of the first substrate 10 and the liquid crystal panel 5a. For this reason, since it is possible to block the light leaking from the light source of the liquid crystal device 5 or the end portion of the light guide plate, the light is prevented from leaking from the second substrate 20 to the emission side (the input manipulation side) of the display light. Since other structures are the same as those in Embodiment 1, a description thereof is omitted here for the sake of simplicity.

For manufacturing the electrostatic capacitance type input apparatus 1 and the display apparatus 100 with the input function which are structured in the manner as described above, after the light blocking sheet 99 is stuck to the first surface 10a side of the first substrate 10, the gel-like sheet 41a is stuck to the first surface 10a side of the first substrate 10. Next, when the first substrate 10 and the second substrate 20 are stacked one upon another so as to sandwich the gel-like sheet 41a between them, the first substrate 10 and the second substrate 20 can be disposed integrally with each other through the gel-like sheet 41a.

In addition, the light blocking sheet 99 is stuck to the first surface 10a side of the first substrate 10, and at the same time, the gel-like sheet 41a is stuck to the first surface 20a side of the second substrate 20, and thereafter, the first substrate 10 and the second substrate 20 may be stacked one upon another so as to sandwich the gel-like sheet 41a between them.

As has been described so far, even in the electrostatic capacitance type input apparatus 1 and the display apparatus 100 with the input function of Change of Embodiment 1, the electrostatic capacitance type input apparatus 1 also offers the same effects that the input manipulation can be carried out by using the pen or the like other than the finger, the mechanical strength of the second substrate 20 is high, and so forth as those in Embodiment 1 similarly to the case of Embodiment 1.

It is noted that although in Change of Embodiment 1, the rectangular frame-like light blocking sheet 99 is provided between the first substrate 10 and the gel-like sheet 41a, the rectangular frame-like light blocking sheet 99 may also be provided between the second substrate 20 and the gel-like sheet 41a.

### Embodiment 2

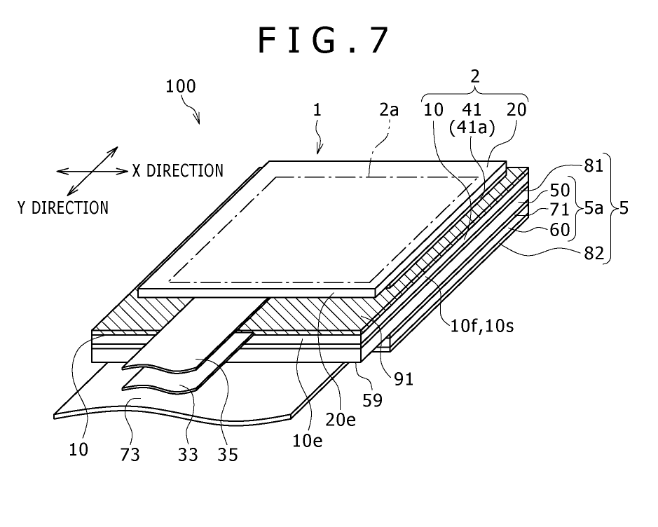

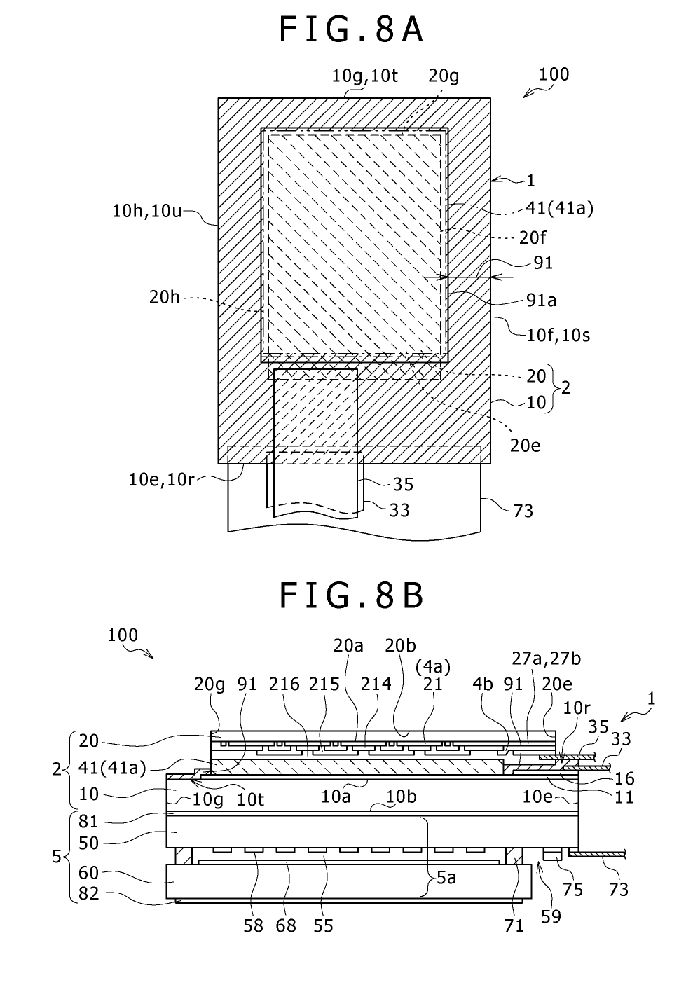

FIG. 7 is an explanatory perspective view schematically showing an entire structure of a display apparatus 100 with an input function according to Embodiment 2 of the present invention. FIGS. 8A and 8B are respectively explanatory views schematically showing a positional relationship and the like of members composing the display apparatus 100 with the input function according to Embodiment 2 of the present invention. That is to say, FIGS. 8A and 8B are respectively an explanatory top plan view schematically showing a planar structure of the display apparatus 100 with the input function of Embodiment 2, and an explanatory cross sectional view schematically showing a cross sectional structure of the display apparatus 100 with the input function of Embodiment 2. It is noted that in FIG. 7, the light blocking sheet is represented by downward-sloping slant lines. In addition, in FIG. 8A, the first substrate used in the electrostatic capacitance type input apparatus is represented by a heavy solid line, and the flexible second substrate used in the electrostatic capacitance type input apparatus is represented by a heavy and long dotted line. The input area is represented by a chain line, and the light blocking sheet is represented by a fine solid line and an area indicated by an upward-sloping solid lines. Also, the elastic member (gel-like sheet) is represented by a two-dot chain line and an area indicated by downward-sloping dotted lines. In addition, since the basic structure of Embodiment 2 is the same as that of Embodiment 1, the common portions are designated by the same reference numerals, respectively, and a description thereof is omitted here for the sake of simplicity.

Referring to FIG. 7, and FIGS. 8A and 8B, the display apparatus 100 with the input function of Embodiment 2 also includes the liquid crystal device 5 as the image producing device, and the electrostatic capacitance type input apparatus 1 disposed so as to overlie the surface on the side from which the display light is emitted in the liquid crystal device 5 similarly to the case of Embodiment 1. In Embodiment 2, the liquid crystal device 5 includes the transmission type or semi-transmission and reflection type liquid crystal panel 5a. In the liquid crystal device 5, the backlight unit (not shown) is disposed on the side (the side opposite to the emission side of the display light) opposite to the side on which the electrostatic capacitance type input apparatus 1 is disposed with respect to the liquid crystal panel 5a.

In the electrostatic capacitance type input apparatus 1 in the display apparatus 100 with the input function of Embodiment 2, the input panel 2 includes the translucent first substrate 10 made from the glass plate, the plastic plate or the like, and the translucent second substrate 20 made from the glass plate, the plastic plate, the plastic sheet or the like. In Embodiment 2, the plastic sheet is used as the second substrate 20, and the glass plate is used as the first substrate 10. The first electrode 11 for the detection of the depressed position is formed on the first surface 10a of the first substrate 10, and a plurality of first electrodes 11 for the detection of the depressed position is formed on the first surface 20a of the second substrate 20.

The elastic member 41 having the insulating property is provided between the first substrate 10 and the second substrate 20. In Embodiment 2, the elastic member 41 is the gel-like sheet 41a which is disposed so as to overlie and underlie the first substrate 10 and the second substrate 20, respectively. The gel-like sheet 41a is made of the silicon resin or the like having the translucency, the elasticity and the adherence property, and a thickness thereof is in the range of 100 to 500 μm. In Embodiment 2, the member having an elastic modulus which is equal to or larger than 1×10⁴N/m², and is equal to or smaller than 1×10⁸ N/m² is used as the gel-like sheet 41a.

Here, the first substrate 10 of the electrostatic capacitance type input apparatus 1 has approximately the same size of the element substrate 50 of the liquid crystal device 5. On the other hand, the second substrate 20 of the electrostatic capacitance type input apparatus 1 has the smaller size than that of the first substrate 10, and the first substrate 10 includes protrusion portions 10r, 10s, 10t, and 10u each protruding from the edge of the second substrate 20 in the circumference of the second substrate 20. Here, the gel-like sheet 41a has approximately the same size as that of the second substrate 20, and thus is provided in none of the protrusion portions 10r, 10s, 10t, and 10u.

In the electrostatic capacitance type input apparatus 1 of Embodiment 2, for the purpose of blocking the light leaking from the light source of the liquid crystal device 5 or the end portion of the light guide plate, the rectangular frame-like light blocking sheet 99 is provided along the outer peripheral edge of the second substrate 20 in the protrusion portions 10r, 10s, 10t, and 10u of the first substrate 10. Here, the light blocking sheet 99 overlap each of the outer peripheral side edge portions of the first substrate 10 and the liquid crystal panel 5a in terms of a planar view. In addition, an inner peripheral edge 99a of the light blocking sheet 99 overlaps each of the outer peripheral edge of the second substrate 20, and the outer peripheral edge of the gel-like sheet 41a in terms of the planar view. For this reason, since it is possible to block the light leaking from the light source of the liquid crystal device 5 or the end portion of the light guide plate by the light blocking sheet 99, the light is prevented from leaking from the second substrate 20 to the emission side (the input manipulation side) of the display light. Since other structures are the same as those in Embodiment 1, a description thereof is omitted here for the sake of simplicity.

For manufacturing the electrostatic capacitance type input apparatus 1 and the display apparatus 100 with the input function which are structured in the manner as described above, after the light blocking sheet 99 is stuck to the first surface 10a side of the first substrate 10, the gel-like sheet 41a is stuck to the first surface 10a side of the first substrate 10. Next, when the first substrate 10 and the second substrate 20 are stacked one upon another so as to sandwich the gel-like sheet 41a between them, the first substrate 10 and the second substrate 20 can be disposed integrally with each other through the gel-like sheet 41a.

In addition, the light blocking sheet 99 is stuck to the first surface 10a side of the first substrate 10, and at the same time, the gel-like sheet 41a is stuck to the first surface 20a side of the second substrate 20, and thereafter, the first substrate 10 and the second substrate 20 may be stacked one upon another so as to sandwich the gel-like sheet 41a between them.

Even in the electrostatic capacitance type input apparatus 1 and the display apparatus 100 with the input function structured in the manner as described above, the electrostatic capacitance type input apparatus 1 also offers the same effects that the input manipulation can be carried out by using the pen or the like other than the finger, the mechanical strength of the second substrate 20 is high, and so forth as those in the case of Embodiment 1 similarly to the case of Embodiment 1.

In addition, in Embodiment 2, the light blocking sheet 99 is provided in each of the protrusion portions 10r, 10s, 10t, and 10u each protruding from the end edge of the second substrate 20 in the first substrate 10. To this end, during assembly of the electrostatic capacitance type input apparatus 1, the light blocking sheet 99 can be provided in any of the process before the first substrate 10 and the flexible second substrate 20 are stuck to each other through the gel-like sheet 41a, the process after the first substrate and the second substrate 20 are stuck to each other through the gel-like sheet 41a.

For example, it is possible to adopt a method in which after the light blocking sheet 99 and the gel-like sheet 41a are stuck to each of the protrusion portions 10r, 10s, 10t, and 10u of the first substrate 10, the first substrate 10 and the second substrate 20 are stacked one upon another so as to sandwich the gel-like sheet 41a between them, and thus the first substrate 10 and the second substrate 20 are disposed integrally with each other through the gel-like sheet 41a. In addition, it is also possible to adopt a method in which while the light blocking sheet 99 is stuck to each of the protrusion portions 10r, 10s, 10t, and 10u of the first substrate 10, the gel-like sheet 41a is stuck to the second substrate 20, and thereafter, the first substrate 10 and the second substrate 20 are stacked one upon another so as to sandwich the gel-like sheet 41a between them, and thus the first substrate 10 and the second substrate 20 are disposed integrally with each other through the gel-like sheet 41a. Moreover, a method in which after the first substrate 10 and the second substrate 20 are disposed integrally with each other through the gel-like sheet 41a, the light blocking sheet 99 is stuck to each of the protrusion portions 10r, 10s, 10t, and 10u of the first substrate 10 may also be adopted depending on the substrate sizes.

### Embodiment 3

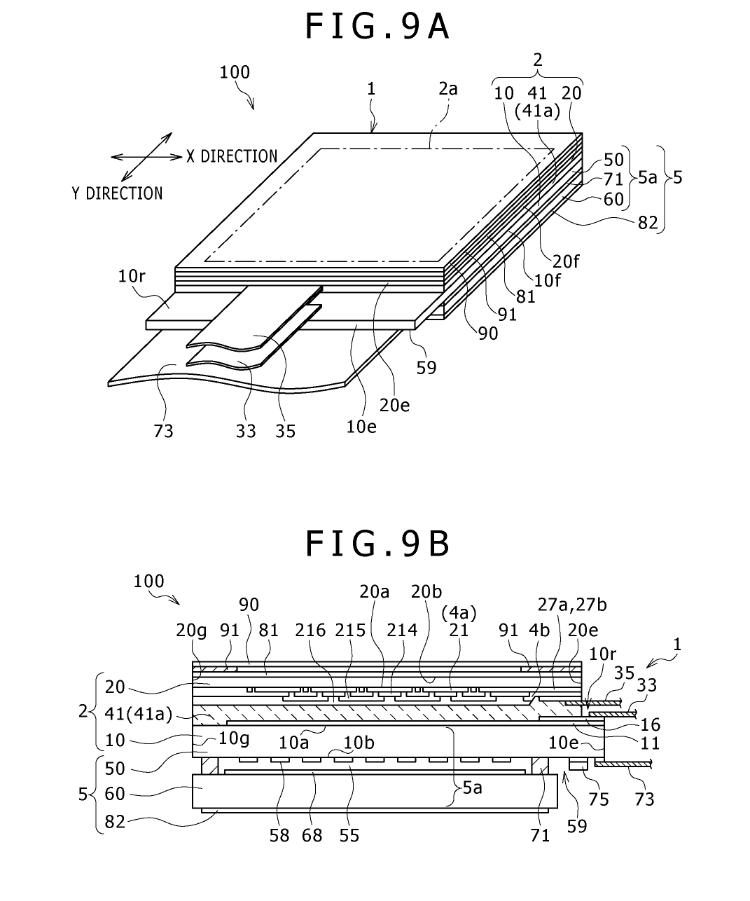

FIGS. 9A and 9B are respectively explanatory views schematically showing a structure of a display apparatus 100 with an input function according to Embodiment 3. That is to say, FIGS. 9A and 9B are respectively an explanatory perspective view schematically showing an entire structure of the display apparatus 100 with the input function according to Embodiment 3 of the present invention, and an explanatory cross sectional view schematically showing a cross sectional structure of the display apparatus 100 with the input function according to Embodiment 3. It is noted that in FG. 9A, the light blocking portion of the transparent protective film is represented by downward-sloping slant lines. In addition, since the basic structure of Embodiment 3 is the same as that of Embodiment 1, the common portions are designated by the same reference numerals, respectively, and a description thereof is omitted here for the sake of simplicity.

Referring to FIGS. 9A and 9B, the display apparatus 100 with the input function of Embodiment 3 also includes the liquid crystal device 5 as the image producing device, and the electrostatic capacitance type input apparatus 1 disposed so as to overlie the surface on the side from which the display light is emitted in the liquid crystal device 5 similarly to the case of Embodiment 1. In Embodiment 3, the liquid crystal device 5 includes the transmission type or semi-transmission and reflection type liquid crystal panel 5a. In the liquid crystal device 5, the backlight unit (not shown) is disposed on the side (the side opposite to the emission side of the display light) opposite to the side on which the electrostatic capacitance type input apparatus 1 is disposed with respect to the liquid crystal panel 5a.

In the electrostatic capacitance type input apparatus 1 in the display apparatus 100 with the input function of Embodiment 3, the input panel 2 includes the translucent first substrate 10 made from the glass plate, the plastic plate or the like, and the translucent second substrate 20 made from the glass plate, the plastic plate, the plastic sheet or the like. In Embodiment 3, the plastic sheet is used as the second substrate 20, and the glass plate is used as the first substrate 10. The first electrode 11 for the detection of the depressed position is formed on the first surface 10a of the first substrate 10, and a plurality of second electrodes 21 for the detection of the depressed position is formed on the first surface 20a of the second substrate 20.

The elastic member 41 having the insulating property is provided between the first substrate 10 and the second substrate 20. In Embodiment 3, the elastic member 41 is the gel-like sheet 41a which is disposed between the first substrate 10 and the second substrate 20 so as to overlie and underlie the first substrate 10 and the second substrate 20, respectively. The gel-like sheet 41a is made of the silicon resin or the like having the translucency, the elasticity and the adherence property, and a thickness thereof is in the range of 100 to 500 μm. In Embodiment 3, the member having the elastic modulus which is equal to or larger than 1×10⁴ N/m², and is equal to or smaller than 1×10⁸ N/m² is used as the gel-like sheet 41a. It is noted that the transparent protective film 90 having the rectangular frame-like light blocking portion 92 is stuck to the second surface 20b of the second substrate 20.

In the display apparatus 100 with the input function structured in the manner as described above, the first substrate 10 of the electrostatic capacitance type input apparatus 1 is utilized as the element substrate 50 as well of the liquid crystal device 5. Also, the pixel electrodes 58 and the like are formed on the second surface 10b of the first substrate 10. For this reason, the second polarizing plate 82 is stuck to the second surface 20b of the second substrate 20 of the electrostatic capacitance type input apparatus 1. Since other structures are the same as those in Embodiment 1, a description thereof is omitted here for the sake of simplicity.

Even in the electrostatic capacitance type input apparatus 1 and the display apparatus 100 with the input function of Embodiment 3, the electrostatic capacitance type input apparatus 1 also offers the same effects that the input manipulation can be carried out by using the pen or the like other than the finger, the mechanical strength of the second substrate 20 is high, and so forth as those in the case in Embodiment 1 similarly to the case of Embodiment 1.

In addition, in Embodiment 3, the first substrate 10 is used as the element substrate 50 as well of the liquid crystal device 5. For this reason, since the number of sheets of substrates composing the display apparatus 100 with the input function is less, it is possible to thin the display apparatus 100 with the input function.

Although in Embodiment 3, the structure such that the first substrate 10 is used as the element substrate 50 as well of the liquid crystal device 5 is applied to Embodiment 1, a structure such that the first substrate 10 is used as the element substrate 50 as well of the liquid crystal device 5 may be applied to Change of Embodiment 1, or Embodiment 2.

[Change of Embodiment 3]

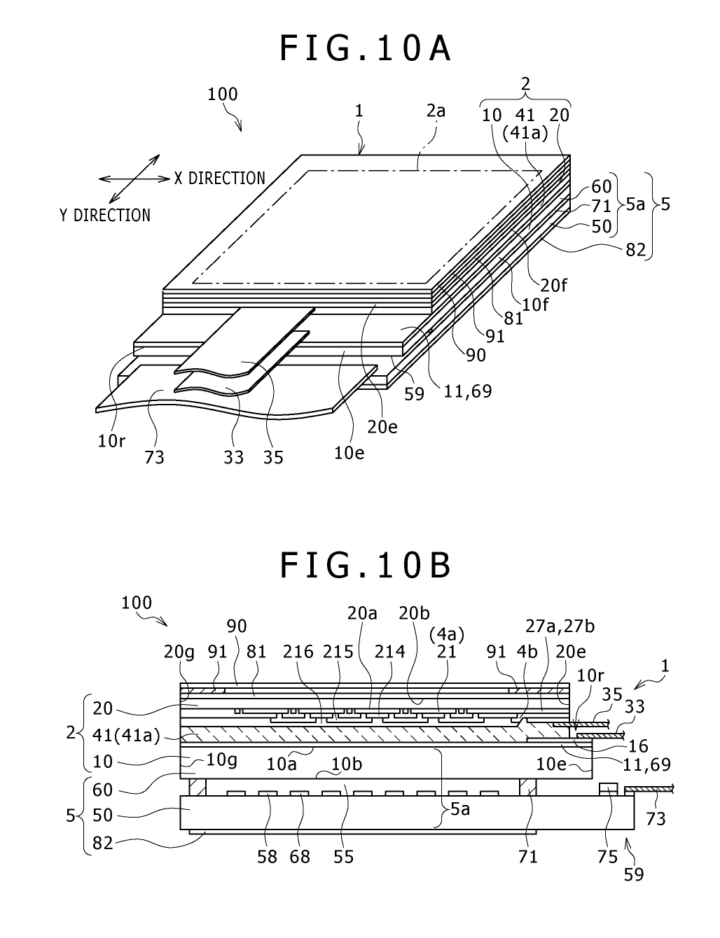

FIGS. 10A and 10B are respectively explanatory views schematically showing a structure of a display apparatus 100 with an input function according to Change of Embodiment 3. That is to say, FIGS. 10A and 10B are respectively an explanatory perspective view schematically showing an entire structure of the display apparatus 100 with the input function according to Change of Embodiment 3 of the present invention, and an explanatory cross sectional view schematically showing a cross sectional structure of the display apparatus 100 with the input function according to Change of Embodiment 3. It is noted that in FIG. 10A, the light blocking sheet as the light blocking member is represented by downward-sloping slant lines. In addition, since the basic structure of Change of Embodiment 3 is the same as that of each of Embodiments 1 and 3, the common portions are designated by the same reference numerals, respectively, and a description thereof is omitted here for the sake of simplicity.

Referring to FIGS. 10A and 10B, the display apparatus 100 with the input function of Change of Embodiment 3 also includes the liquid crystal device 5 as the image producing device, and the electrostatic capacitance type input apparatus 1 disposed so as to overlie the surface on the side from which the display light is emitted in the liquid crystal device 5 similarly to the case of each of Embodiments 1 and 3. In Change of Embodiment 3, the liquid crystal device 5 includes the transmission type or semi-transmission and reflection type liquid crystal panel 5a. In the liquid crystal device 5, the backlight unit (not shown) is disposed on the side (the side opposite to the emission side of the display light) opposite to the side on which the electrostatic capacitance type input apparatus 1 is disposed, with respect to the liquid crystal panel 5a.

Here, the liquid crystal panel 5a is a panel utilizing either the IPS system or the FFS system, and the pixel electrodes 58 and the common electrode 68 are both formed on the side of the element substrate 50. In addition, the liquid crystal panel 5a is formed on the input manipulation side with respect to the element substrate 50. Also, a back surface electrode 69 made from a translucent conductive film such as the ITO film is formed on the surface (the surface on the input manipulation side) opposite side to the side facing the element substrate 50. Such a back surface electrode 69 prevents the element substrate 50 from being influenced by the static electricity or the electromagnetic noise

In the electrostatic capacitance type input apparatus 1 in the display apparatus 100 with the input function of Change of Embodiment 3, the input panel 2 includes the translucent first substrate 10 made from the glass plate, the plastic plate or the like, and the translucent second substrate 20 made from the glass plate, the plastic plate, the plastic sheet or the like. In Change of Embodiment 3, the plastic sheet is used as the second substrate 20, and the glass plate is used as the first substrate 10. The first electrode 11 for the detection of the depressed position is formed on the first surface 10a of the first substrate 10, and a plurality of second electrodes 21 for the detection of the depressed position are formed on the first surface 20a of the second substrate 20.

Here, the first substrate 10 of the electrostatic capacitance type input apparatus 1 is used as the counter substrate 60 as well of the liquid crystal device 5. For this reason, the back surface electrode 69 is formed on the first surface 10a of the first substrate 10, and thus such a back surface electrode 69 is utilized as the first electrode 11 of the electrostatic capacitance type input apparatus 1. It is noted that the second polarizing plate 82 is stuck to the second surface 20b of the second substrate 20 of the electrostatic capacitance type input apparatus 1.

Also in Change of Embodiment 3, similarly to each of Embodiments 1 and 3, the elastic member 41 having the insulating property is provided between the first substrate 10 and the second substrate 20. In Change of Embodiment 3, the elastic member 41 is the gel-like sheet 41a which is disposed so as to overlie and underlie the first substrate 10 and the second substrate 20, respectively. The gel-like sheet 41a is made of the silicon resin or the like having the translucency, the elasticity and the adherence property, and a thickness thereof is in the range of 100 to 500 μm. In Change of Embodiment 3, the member having an elastic modulus which is equal to or larger than 1×10⁴ N/m², and is equal to or smaller than 1×10⁸ N/m² is used as the gel-like sheet 41a. It is noted that the transparent protective film 90 having the rectangular frame-like light blocking portion 92 is stuck to the second surface 20b of the second substrate 20. Since other structures are the same as those in Embodiment 3, a description thereof is omitted here for the sake of simplicity.

Even in the electrostatic capacitance type input apparatus 1 and the display apparatus 100 with the input function of Change of Embodiment 3, the electrostatic capacitance type input apparatus 1 also offers the same effects that the input manipulation can be carried out by using the pen or the like other than the finger, the mechanical strength of the second substrate 20 is high, and so forth as those in the case of Embodiment 1 similarly to the case of Embodiment 1. In addition, in Change of Embodiment 3, the first substrate 10 is used as the counter substrate 60 as well of the liquid crystal device 5, and the back surface electrode 69 is utilized as the first electrode 11 of the electrostatic capacitance type input apparatus 1. For this reason, the second substrate 20 has to be stuck to the liquid crystal panel 5a utilizing either the IPS system or the FFS system through the gel-like sheet 41a. Therefore, since the number of sheets of substrates composing the display apparatus 100 with the input function is less, it is possible to thin the display apparatus 100 with the input function.

### Embodiment 4

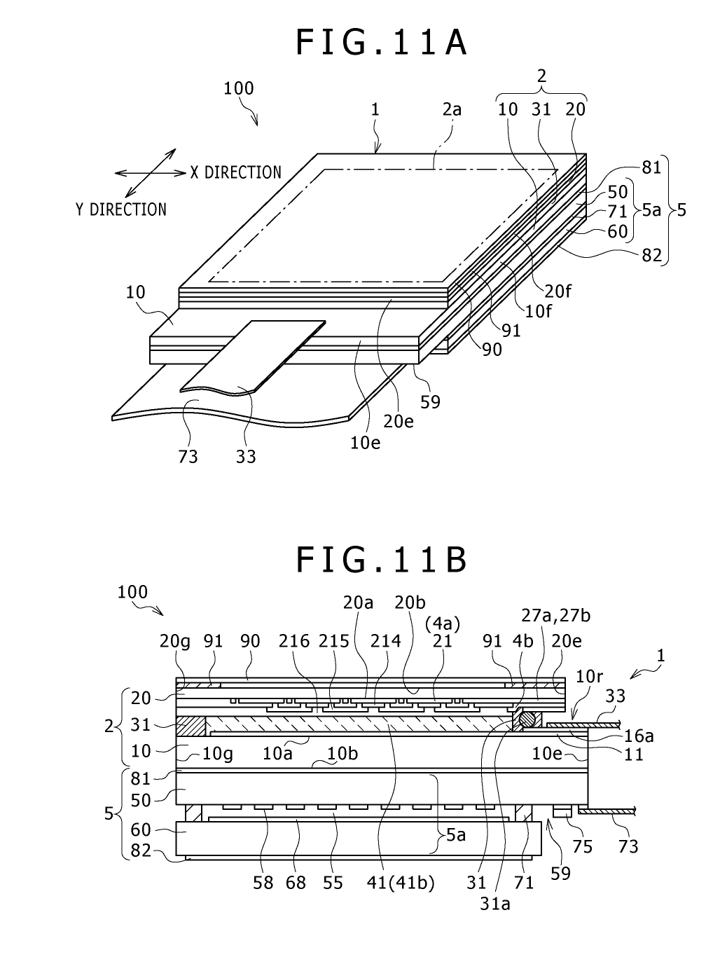

FIGS. 11A and 11B are respectively explanatory views schematically showing a structure of a display apparatus 100 with an input function according to Embodiment 4. That is to say, FIGS. 11A and 11B are respectively an explanatory perspective view schematically showing a planar structure of the display apparatus 100 with the input function of Embodiment 4, and an explanatory cross sectional view schematically showing a cross sectional structure of the display apparatus 100 with the input function of Embodiment 4. It is noted that in FIG. 11A, the light blocking portion of the transparent protective film is represented by downward-sloping slant lines. In addition, since the basic structure of Embodiment 3 is the same as that of Embodiment 1, the common portions are designated by the same reference numerals, respectively, and a description thereof is omitted here for the sake of simplicity.

Referring to FIGS. 11A and 11B, the display apparatus 100 with the input function of Embodiment 4 also includes the liquid crystal device 5 as the image producing device, and the electrostatic capacitance type input apparatus 1 disposed so as to overlie the surface on the side from which the display light is emitted in the liquid crystal device 5 similarly to the case of Embodiment 1. In Embodiment 4, the liquid crystal device 5 includes the transmission type or semi-transmission and reflection type liquid crystal panel 5a. In the liquid crystal device 5, the backlight unit (not shown) is disposed on the side (the side opposite to the emission side of the display light) opposite to the side on which the electrostatic capacitance type input apparatus 1 is disposed with respect to the liquid crystal panel 5a.

In the electrostatic capacitance type input apparatus 1 in the display apparatus 100 with the input function of Embodiment 4, the input panel 2 includes the translucent first substrate 10 made from the glass plate, the plastic plate or the like, and the translucent second substrate 20 made from the glass plate, the plastic plate, the plastic sheet or the like. In Embodiment 4, the plastic sheet is used as the second substrate 20, and the glass plate is used as the first substrate 10. The first electrode 11 for the detection of the depressed position is formed on the first surface 10a of the first substrate 10, and a plurality of second electrodes 21 for the detection of the depressed position are formed on the first surface 20a of the second substrate 20.

In the electrostatic capacitance type input apparatus 1 and the display apparatus 100 with the input function of Embodiment 4, the first substrate 10 and the second substrate 20 are stuck to each other through a predetermined gap by the rectangular frame-like seal member 31 provided along the outer peripheral edge of the second substrate 20. In addition, the elastic member 41 having the insulating property is provided between the first substrate 10 and the second substrate 20 in the inside of the rectangular frame-like seal member 31.

Here, the elastic member 41 is made of a translucent resin composition 41b which is solidified inside the rectangular frame-like seal member 31. For forming the elastic member 41 having such a structure, for example, when the first substrate 10 and the second substrate 20 are stuck to each other through the predetermined gap by the rectangular frame-like seal member 31, an interruption portion is provided in a part of the rectangular frame-like seal member 31. Thus, after a translucent resin material, which has the elasticity after having been solidified, such as a silicon resin, an urethane resin, or an acrylic resin is injected through the interruption portion, the translucent resin material thus injected is solidified either through light curing or thermal curing. In Embodiment 4, a thickness of the elastic member 41 (the resin composition 41b) is in the range of 100 to 500 μm. Also, the member having the elastic modulus which is equal to or larger than 1×10⁴N/m², and is equal to or smaller than 1×10⁸ N/m² under the condition in which the temperature is 20° C. is used as the elastic member 41. It is noted that the transparent protective film 90 having the rectangular frame-like light blocking portion 92 is stuck to the second surface 20b of the second substrate 20.

In addition, Embodiment 4 adopts the structure such that the first substrate 10 and the second substrate 20 are stuck to the end portion by the seal material 31. Therefore, inter-substrate conduction is carried out for the first substrate 10 and the second substrate 20, and electrical connection to the second substrate 20 is carried out through the flexible substrate 33 connected to the first substrate 10. For carrying out the inter-substrate conduction, the terminal 16a is provided in a position overlapping the terminals of the wirings 27a and the wirings 27b of the second substrate 20 in the area, avoiding the first electrode 11, of the first surface 10a of the first substrate 10. Also, conductive particles are blended in a portion for application to a formation area of at least the terminal 16a in the seal material 31. Therefore, when the terminal 16a and the wiring of the flexible substrate 33 are electrically connected to each other, the wiring of the flexible substrate 33, and the wirings 27a and the wirings 27b of the second substrate 20 can be electrically connected to each other.

Even in the electrostatic capacitance type input apparatus 1 and the display apparatus 100 with the input function which are structured in the manner as described above, the electrostatic capacitance type input apparatus 1 also offers the same effects that the input manipulation can be carried out by using the pen or the like other than the finger, the mechanical strength of the second substrate 20 is high, and so forth as those in the case of Embodiment 1 similarly to the case of Embodiment 1.

It is noted that although in Embodiment 4, the structure such that the seal material 31 is utilized is applied to Embodiment 1, the structure such that the seal material 31 is utilized may also be applied to Change of Embodiment 1, Embodiment 2 or Embodiment 3.

[Change 1 of Electrode for Detection of Depressed Position]

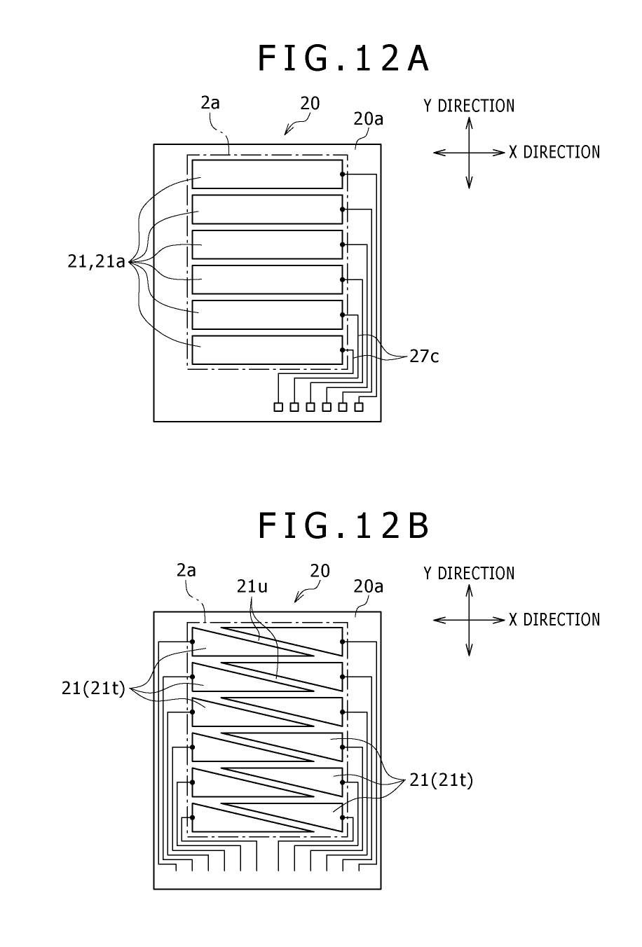

FIGS. 12A and 12B are respectively explanatory views showing Change 1 of the electrode for the detection of the depressed position which is formed in the electrostatic capacitance type input apparatus 1 and the display apparatus 100 with the input formation to which the present invention is applied. That is to say, FIGS. 12A and 12B are respectively an explanatory top plan view when the six second electrodes 21 in total are formed on the second substrate 20, and an explanatory top plan view when the 12 second electrodes 21 in total are formed on the second substrate 20.

In each of Embodiments 1 to 4, a plurality of second electrodes 21 is made to extend in the X-direction and in the Y-direction on the second surface 20b of the second substrate 20. Alternatively, however, a structure may also be adopted such that as shown in FIG. 12A, a plurality of strip-shaped electrodes 21a each extending in the X-direction are arranged in parallel with the Y-direction on the first surface 20a of the second substrate 20. Here, wirings 27c extend from a plurality of strip-shaped electrodes 21a, respectively, on the first surface 20a of the second substrate 20. On the other hand, the planar first electrode 11 is formed on the first substrate 10 similarly to the case of Embodiment 1.

In addition, a structure may also be adopted such that as shown in FIG. 12B, multiple pairs of electrodes in which each paired strip-shaped electrodes 21t having vertexes each directed in the X-direction are arranged on the first surface 20a of the second substrate 20 so that each adjacent oblique sides face each other through a slit 21u. Here, wirings 27b extend from a plurality of strip-shaped electrodes 21t, respectively, on the first surface 20a of the second substrate 20. On the other hand, the planar first electrode 11 is formed on the first substrate 10 similarly to the case of Embodiment 1.

[Change 2 of Electrode for Detection of Depressed Position]

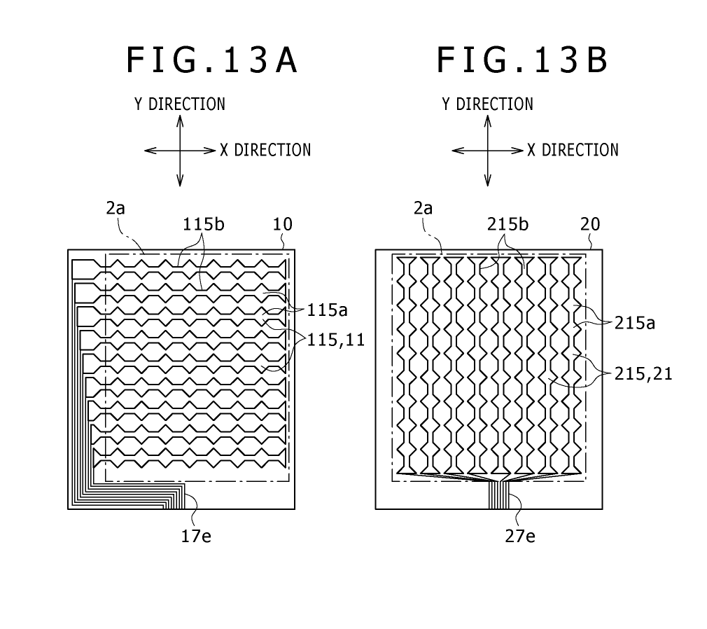

FIGS. 13A and 13B are respectively explanatory views showing Change 2 of the electrode for the detection of the depressed position which is formed in the electrostatic capacitance type input apparatus 1 and the display apparatus 100 with the input formation to which the present invention is applied. That is to say, FIGS. 13A and 13B are respectively an explanatory top plan view showing a structure of the first electrode 11, and an explanatory top plan view showing a structure of the second electrode 21.

In each of Embodiments 1 to 4, the first electrode 11 is formed in a planar shape. However, in Change 2, as shown in FIG. 13A, a plurality of first electrodes 11 each extending in the X-direction are provided over the input area 2a on the first surface 10a of the first substrate 10. Also, wirings 17e are provided so as to be electrically connected to the first electrodes 11, respectively. In addition, as shown in FIG. 13B, a plurality of second electrodes 21 each extending in the Y-direction are provided over the input area 2a on the first surface 20a of the second substrate 20. Also, wirings 27e are provided so as to be electrically connected to the second electrodes 21, respectively. In Change 2, each of the first electrode 11 and the second electrode 21 is made from the translucent conductive film such as the ITO film.

Here, each of the first electrodes 11 includes a plurality of rhomboid-shaped pad portions 115a each having a large area, and each two adjacent rhomboid-shaped pad portions 115a are linked to each other through a narrow interlinking portion 115b. In addition, each of the second electrodes 21 also includes a plurality of rhomboid-shaped pad portions 215a each having a large area, and each two adjacent rhomboid-shaped pad portions 215a are linked to each other through a narrow interlinking portion 215b similarly to the case of the first electrode 11.

The first substrate 10 and the second substrate 20 which are structured in the manner as described above, for example, are disposed in such a way that the rhomboid-shaped pad portions 115a and the rhomboid-shaped pad portions 215a perfectly overlap each other. In addition, there are executed processing for applying a constant voltage to the first electrode 11, and monitoring the electrostatic capacitances coupled to a plurality of second electrodes 21, respectively, and processing for applying a constant voltage to the second electrode 21, and monitoring the electrostatic capacitances coupled to a plurality of first electrodes 11, respectively.

With such a structure as well, during the carrying-out of the input manipulation, when a user depresses a predetermined position of the flexible second substrate 20 by using his/her finger, the pen or the like, the depressed portion of the flexible second substrate 20 is bent toward the side of the first substrate 10, and thus the distance between the first electrode 11 and the second electrode 21 is changed. As a result, the electrostatic capacitance is changed accordingly. Therefore, of a plurality line of first electrodes 11 and second electrodes 21, the electrode with which the electrostatic capacitance is changed is specified, thereby making it possible to specify the coordinates of the depressed position.

### Other Embodiments

In each of Embodiments 1 to 4 described above, the first electrode 11 is formed on the first surface 10a of the first substrate 10, and a plurality of second electrodes 21 are formed on the first surface 20a of the second substrate 20. However, a structure may also be adopted such that a plurality of second electrodes 21 are formed on the second surface 20b of the second substrate 20. In addition thereto, there may also be adopted a structure such that the first electrode 11 is formed either on the second surface 10b of the first substrate 10, or a structure such that the first electrode 11 is formed on the element substrate 50 or on the counter substrate 60 of the liquid crystal panel 5a.

In each of Embodiments 1 to 4 described above, the first electrode 11 is formed in the planar shape on the first substrate 10, and a plurality of second electrodes 21 are formed on the second substrate 20. Alternatively, however, a structure may also be adopted such that the second electrode 21 is formed in the planar shape on the second substrate 20, and a plurality of first electrodes 11 are formed on the first substrate 10.

Although in each of Embodiments 1 to 4 described above, the liquid crystal device 5 is used as the image producing device, an organic electroluminescence device may be used as the image producing device instead.

It should be noted that the electrostatic capacitance type input apparatus 1 of the present invention incorporated in the display apparatus 100 with the input function of the present invention are embodied as described in Embodiments 1 to 4 described above of the display apparatus 100 with the input function of the present invention.

Examples of Mounting of Display Apparatus 100 with Input Function to Electronic Apparatuses

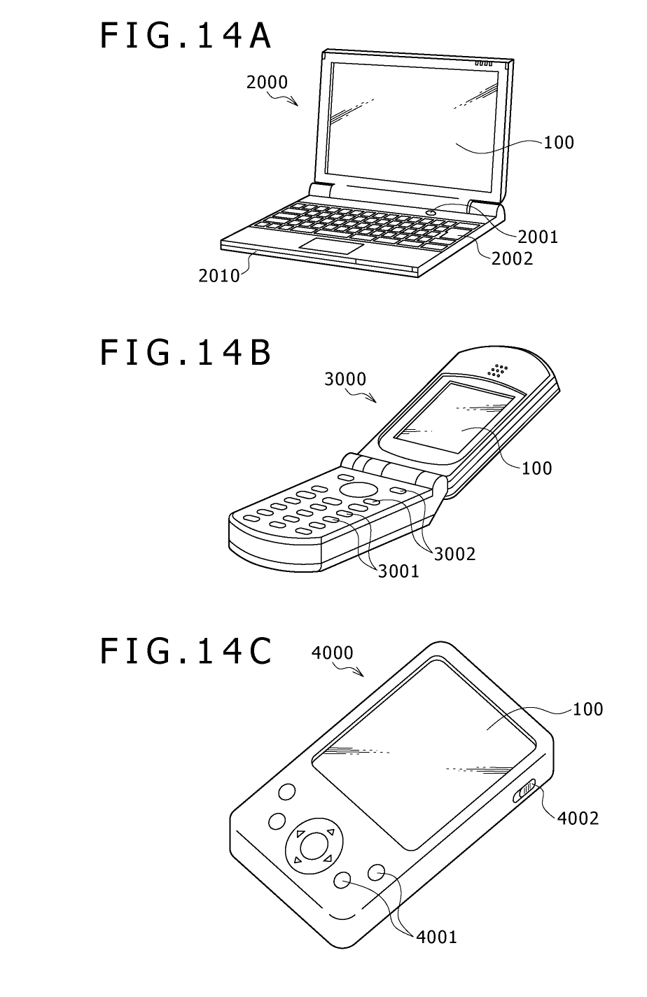

Next, a description will be given with respect to electronic apparatuses to each of which the display apparatus 100 with the input function according to any of Embodiments 1 to 4 described above of the present invention is applied. FIG. 14A is an explanatory perspective view showing a construction of a mobile type personal computer including the display apparatus 100 with the input function. The mobile type personal computer 2000 includes the display apparatus 100 with the input function as a display unit, and a main body portion 2010. The main body portion 2010 is provided with a power source switch 2001 and a keyboard 2002. FIG. 14B is an explanatory perspective view showing a construction of a mobile phone including the display apparatus 100 with the input function. The mobile phone 3000 includes a plurality of manipulation buttons 3001, a plurality of scroll buttons 3002, and the display apparatus 100 with the input function as a display unit. By manipulating the scroll buttons 3002, a picture displayed on the display apparatus 100 with the input function is scrolled. FIG. 14C is an explanatory perspective view showing a construction of Personal Digital Assistants (PDA) to which the display apparatus 100 with the input function is applied. The PDA 4000 includes a plurality of manipulation buttons 4001, a power source switch 4002, and the display apparatus 100 with the input function as a display unit. By manipulating the power source switch 4002, any of various pieces of information such as an address list or an appointment book is displayed on the display apparatus 100 with the input function.

It is noted that in addition to the personal computer 2000, the mobile phone 3000, and the PDA 4000 shown in FIGS. 14A, 14B and 14C, respectively, electronic apparatuses such as a digital still camera, a liquid crystal television set, a view finder type video tape recorder, a monitor direct-view-type video tape recorder, a car navigation system, a pager, an electronic databook, an electronic calculator, a word processor, a work station, a TV telephone, a POS terminal, and a banking terminal are given as the electronic apparatuses to each of which the display apparatus 100 with the input function is applied. Also, the display apparatus 100 with the input function described above can be applied as each of the display portions of those kinds of electronic apparatuses.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An electrostatic capacitance type input apparatus, comprising:
a first substrate;
a flexible second substrate disposed so as to face said first substrate;
a first electrode for detection of a depressed position, said first electrode being provided either on a surface side, in said first substrate, facing said flexible second substrate or on a side opposite to said flexible second substrate with respect to said first substrate;
a second electrode for detection of a depressed position, said second electrode being provided on said flexible second substrate; and
an elastic member having an insulating property and provided between said first substrate and said flexible second substrate.

2. The electrostatic capacitance type input apparatus according to claim 1, wherein said flexible second substrate is made from a plastic sheet.

3. The electrostatic capacitance type input apparatus according to claim 1, wherein said elastic member having the insulating property is a gel-like sheet which is disposed so as to be interposed between said first substrate and said flexible second substrate.

4. The electrostatic capacitance type input apparatus according to claim 3, wherein said gel-like sheet is adhered to each of said first substrate and said flexible second substrate.

5. The electrostatic capacitance type input apparatus according to claim 3, wherein an elastic modulus of said gel-like sheet under a condition in which a temperature is 20° C. is equal to or larger than 1×10⁴N/m², and is equal to or smaller than 1×10⁸ N/m².

6. The electrostatic capacitance type input apparatus according to claim 3, wherein a light blocking member is provided along an outer peripheral edge of said flexible second substrate in any one of a first surface of said flexible second substrate, between said flexible second substrate and said gel-like sheet, and between said gel-like sheet and said first substrate.

7. The electrostatic capacitance type input apparatus according to claim 3, wherein said first substrate includes a protrusion portion protruding from an end edge of said flexible second substrate, and a light blocking member is provided in said protrusion portion along an outer peripheral edge of said flexible second substrate.

8. A display apparatus comprising an input function including said electrostatic capacitance type input apparatus having, a first substrate, a flexible second substrate disposed so as to face said first substrate, a first electrode for detection of a depressed position, said first electrode being provided either on a surface side, in said first substrate, facing said flexible second substrate or on a side opposite to said flexible second substrate with respect to said first substrate, a second electrode for detection of a depressed position, said second electrode being provided on said flexible second substrate, and an elastic member having an insulating property and provided between said first substrate and said flexible second substrate, wherein an image producing device is provided so as to be disposed on a side opposite to said flexible second substrate side with respect to said first substrate.
